(19) United States
(12) Patent Application Publication
(10) Pub. No.: US 2025/0391854 A1
(43) Pub. Date: Dec. 25, 2025

(54) ADDITIVE FOR POSITIVE ELECTRODE, POSITIVE ELECTRODE INCLUDING THE SAME, AND RECHARGEABLE LITHIUM BATTERY INCLUDING THE SAME

(71) Applicant: SAMSUNG SDI CO., LTD., Yongin-si (KR)

(72) Inventors: Moonju CHO, Yongin-si (KR); Hyunwoo KIM, Yongin-si (KR); Seonghyun LIM, Yongin-si (KR); Seung-Hun HAN, Yongin-si (KR); BEOM KWON KIM, Yongin-si (KR)

(21) Appl. No.: 18/908,179

(22) Filed: Oct. 7, 2024

(30) Foreign Application Priority Data
Jun. 21, 2024 (KR) 10-2024-0080788

(51) Int. Cl. H01M 4/525; H01M 4/02; H01M 4/04; H01M 4/505; H01M 4/62; H01M 10/0565; H01M 10/0567

(52) U.S. Cl. CPC H01M 4/525; H01M 4/0404; H01M 4/505; H01M 4/621; H01M 4/625; H01M 10/0565; H01M 10/0567; H01M 2004/028; H01M 2220/30

(57) ABSTRACT

A functional additive for a positive electrode of a rechargeable lithium battery is provided. And more particularly, a positive electrode active material slurry utilized to prepare the positive electrode may include the functional additive, a positive electrode active material, a conductive material, and a binder, wherein the functional additive includes a compound containing a substituted or unsubstituted pyrazole group.

### CROSS-REFERENCE TO RELATED APPLICATION

The present application claims priority to and the benefit of Korean Patent Application No. 10-2024-0080788, filed on Jun. 21, 2024, in the Korean Intellectual Property Office, the entire disclosure of which is incorporated herein by reference.

### BACKGROUND

### 1. Field

One or more embodiments of the present disclosure relate to an additive for a positive electrode of a rechargeable lithium battery.

### 2. Description of the Related Art

Recently, with the rapid spread and popularization of electronic devices that use batteries, such as mobile phones, laptop computers, and/or electric vehicles, the demand for such batteries, e.g., rechargeable batteries, with relatively high energy density and high capacity has been rapidly increased. Accordingly, research and development efforts have been actively focused (conducted) on improving the performance of such rechargeable batteries, e.g., rechargeable lithium batteries.

The rechargeable lithium battery includes a positive electrode and a negative electrode, each containing an active material capable of intercalation and deintercalation of lithium ions, along with an electrolyte solution. Electrical energy is produced by oxidation and reduction reactions when the lithium ions are intercalated and deintercalated into/from the positive electrode and the negative electrode (e.g., intercalated into the positive electrode and/or deintercalated from the negative electrode during the discharge process).

### SUMMARY

One or more aspects of the present disclosure are directed toward a positive electrode including a functional additive.

One or more aspects of the present disclosure are directed toward a preparation method of a rechargeable lithium battery in which the functional additive is added.

Additional aspects will be set forth in part in the description which follows and, in part, will be apparent from the description, or may be learned by practice of the presented embodiments of the disclosure.

According to one or more embodiments of the present disclosure, a positive electrode active material slurry includes a functional additive, a positive electrode active material, a conductive material, and a binder, wherein the functional additive includes a compound containing a substituted or unsubstituted pyrazole group.

According to one or more embodiments of the present disclosure, a rechargeable lithium battery includes a positive electrode, a negative electrode, and an electrolyte layer between the positive electrode and the negative electrode, the positive electrode includes a positive electrode current collector and a positive electrode active material layer on the positive electrode current collector, and the negative electrode includes a negative electrode current collector and a negative electrode active material layer on the negative electrode current collector, and the positive electrode active material layer is formed by using the positive electrode active material slurry of present disclosure.

According to one or more embodiments of the present disclosure, a preparation method of a rechargeable lithium battery includes preparing a positive electrode, preparing a negative electrode, and combining the positive electrode and the negative electrode to prepare the rechargeable lithium battery, the preparing of the positive electrode includes mixing a positive electrode active material, a conductive material, a binder, and a functional additive to form a positive electrode active material slurry, and applying the positive electrode active material slurry to a positive electrode current collector to form a positive electrode active material layer, and the functional additive includes a compound containing a substituted or unsubstituted pyrazole group.

### BRIEF DESCRIPTION OF DRAWINGS

The accompanying drawings are included to provide a further understanding of the present disclosure, and are incorporated in and constitute a part of this disclosure. The drawings illustrate example embodiments of the present disclosure and, together with the description, serve to explain principles of the disclosure. The above and other aspects, features, and advantages of certain embodiments of the present disclosure will be more apparent from the following description taken in conjunction with the accompanying drawings. In the drawings:

FIG. 1 is a simplified conceptual diagram illustrating a rechargeable lithium battery according to one or more embodiments of the present disclosure;

FIGS. 2-5 are each a cross-sectional view schematically illustrating a rechargeable lithium battery according to one or more embodiments of the present disclosure;

FIG. 6 is a graph showing the results of evaluating viscosities of positive electrode active material slurries according to examples and comparative examples of the present disclosure;

FIG. 7 shows scanning electron microscope (SEM) images obtained by analysis on a surface of a positive electrode active material according to a comparative example of the present disclosure;

FIG. 8 shows SEM images obtained by analysis on a surface of a positive electrode active material according to an example of the present disclosure;

FIG. 9 shows transmission electron microscope (TEM) images obtained by analysis on a surface of a positive electrode active material according to a comparative example of the present disclosure;

FIG. 10 shows TEM images obtained by analysis on a surface of a positive electrode active material according to an example of the present disclosure;

FIG. 11 shows the results of evaluating mixture resistance of positive electrode active materials according to examples and comparative examples of the present disclosure;

FIG. 12 shows the results of evaluating cycle characteristics of rechargeable batteries according to examples and comparative examples of the present disclosure; and

FIGS. 13A, 13B, and 13C each show the results of X-ray photoelectron spectroscope (XPS) analysis on surfaces of positive electrode active materials according to examples and comparative examples of the present disclosure.

### DETAILED DESCRIPTION

In order to fully understand the configurations and aspects of the present disclosure, one or more embodiments of the present disclosure will be described in more detail with reference to the accompanying drawings. The present disclosure may, however, be embodied in one or more suitable forms and should not be construed as limited to example embodiments set forth herein, and one or more suitable changes and modifications may be made. Rather, these embodiments are provided so that this disclosure will be thorough and complete, and will fully convey the scope of the disclosure to those skilled in the art to which the present disclosure pertains.

In the present disclosure, it will be understood that, if (e.g., when) an element is referred to as being on another element, the element may be directly on the other element or intervening elements may be present therebetween. In contrast, if (e.g., when) an element is referred to as being “directly on” another element, there are no intervening elements present. In the drawings, thicknesses of components may be exaggerated for effectively explaining the technical contents. Like reference numerals or symbols refer to like elements throughout the present disclosure, and duplicative descriptions thereof may not be provided for conciseness.

In the present disclosure, the singular forms “a,” “an,” and “the” are intended to include the plural forms as well, unless the context clearly indicates otherwise. Further, the utilization of “may” when describing embodiments of the present disclosure refers to “one or more embodiments of the present disclosure.” In addition, unless otherwise specially noted, the phrase “A or B” or “A and/or B” or “A/B” may indicate “including A but not B, B but not A, or A and B.” The terms “comprise(s)/include(s)” and/or “comprising/including” used in the present disclosure do not exclude the presence or addition of one or more other components.

In the present disclosure, the term “combination thereof” may refer to a mixture, a stack, a composite, a copolymer, an alloy, a blend, and a reaction product of components.

Unless otherwise defined in the disclosure, a particle diameter/size may be an average particle diameter/size. Also, the particle diameter/size refers to an average particle diameter/size (D50) which refers to a diameter/size of particles at a cumulative volume of about 50 vol % in a particle size distribution. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size. The average particle diameter/size (D50) may be measured by a method widely suitable to those skilled in the art, for example, may be measured by a particle size analyzer, for example, HORIBA, LA-950 laser particle size analyzer, or may also be measured using a transmission electron microscope (TEM) image or a scanning electron microscope (SEM) image. In one or more embodiments, the average particle diameter/size may be measured by a measuring device using dynamic light-scattering, wherein the number of particles is counted for each particle size range by performing data analysis, and an average particle diameter/size (D50) value may then be obtained by calculation therefrom. Also, the average particle diameter/size may be measured using a laser diffraction method. When measured by the laser diffraction method, for example, after dispersing particles to be measured in a dispersion medium, the dispersion medium is introduced into a commercial laser diffraction particle size measurement instrument (e.g., Microtrac MT 3000) and irradiated with ultrasonic waves of about 28 kHz at an output of about 60 W, and the average particle diameter/size (D50) based on about 50% of particle size distribution in the measurement instrument may then be calculated. In the present disclosure, when particles are spherical, “diameter/size” indicates an average particle diameter/size, and when the particles are non-spherical, the “diameter/size” indicates a major axis length.

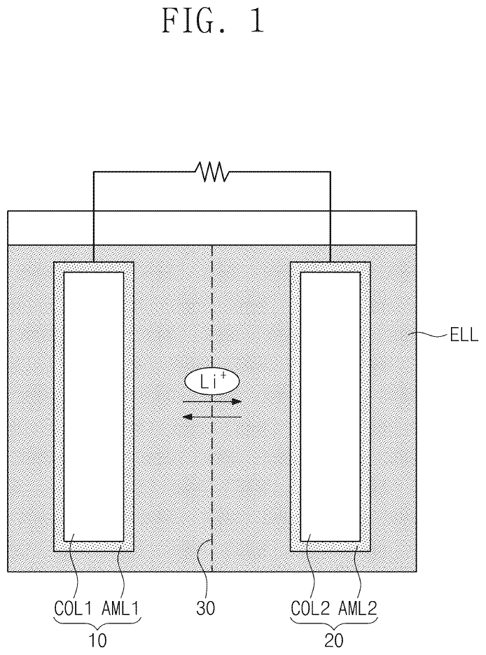

FIG. 1 is a simplified conceptual diagram illustrating a rechargeable lithium battery according to one or more embodiments of the present disclosure. Referring to FIG. 1, a rechargeable lithium battery may include a positive electrode 10, a negative electrode 20, a separator 30, and an electrolyte solution ELL.

The positive electrode 10 and the negative electrode 20 may be spaced and/or apart (e.g., spaced apart or separated) from each other with the separator 30 therebetween. The separator 30 may be arranged between the positive electrode 10 and the negative electrode 20. The positive electrode 10, the negative electrode 20, and the separator 30 (i.e., all three components) may be in contact with the electrolyte solution ELL. Additionally, the positive electrode 10, the negative electrode 20, and the separator 30 (i.e., they all) may be in and/or impregnated with the electrolyte solution ELL.

The electrolyte solution ELL may be a medium for transferring lithium ions between the positive electrode 10 and the negative electrode 20. In the electrolyte solution ELL, the lithium ions may move through the separator 30 toward the positive electrode 10 or the negative electrode 20.

In one or more embodiments, a rechargeable battery containing a gel polymer electrolyte (or a semisolid electrolyte) or a solid electrolyte may include an electrolyte layer. In these embodiments, the electrolyte layer may substitute for roles of the separator 30 and the electrolyte solution ELL.

### Positive Electrode 10

The positive electrode 10 for a rechargeable lithium battery may include a current collector COL1 and a positive electrode active material layer AML1 on the current collector COL1. The positive electrode active material layer AML1 may include a positive electrode active material (e.g., in a form of particles) and may further include a binder and/or a conductive material (e.g., electron conductor). An amount of the positive electrode active material in the positive electrode active material layer AML1 may be about 90 wt % to about 99.5 wt % based on 100 wt % of a total weight of the positive electrode active material layer AML1. An amount of each of the binder and the conductive material may be about 0.5 wt % to about 5 wt % based on 100 wt % of the total weight of the positive electrode active material layer AML1. In one or more embodiments, the positive electrode active material layer AML1 may further include a functional additive ADD. The positive electrode according to one or more embodiments of the present disclosure will be described in more detail later. In one or more embodiments, aluminum (Al) may be used for the current collector COL1, but embodiments of the present disclosure are not limited thereto.

### Positive Electrode Active Material

The positive electrode active material in the positive electrode active material layer AML1 may include a compound (lithiated intercalation compound) that is capable of reversibly intercalating and deintercalating lithium. For example, at least one of a composite oxide of lithium and a metal selected from among cobalt, manganese, nickel, and one or more (e.g., any suitable) combinations thereof may be used.

The composite oxide may be a lithium transition metal composite oxide. Specific examples of the composite oxide may include lithium nickel-based oxides, lithium cobalt-based oxides, lithium manganese-based oxides, lithium iron phosphate-based compounds, cobalt-free nickel-manganese-based oxides, or a (e.g., any suitable) combination thereof.

As an example, a compound represented by any one selected from among the following formulas may be used: LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); and LiₐFePO₄ (0.90≤a≤1.8).

In the above formulas, A is Ni, Co, Mn, or a (e.g., any suitable) combination thereof; X is Al, Ni, Co, Mn, Cr, Fe, Mg, Sr, V, a rare earth element, or a (e.g., any suitable) combination thereof; D is O, F, S, P, or a (e.g., any suitable) combination thereof; G is Al, Cr, Mn, Fe, Mg, La, Ce, Sr, V, or a (e.g., any suitable) combination thereof; and L¹ is Mn, Al, or a (e.g., any suitable) combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol %, based on 100 mol % of the total metal excluding lithium in the lithium transition metal composite oxide. The high-nickel-based positive electrode active material may be capable of realizing high capacity and thus may be applied to a high-capacity, high-density rechargeable lithium battery. That is, in one or more embodiments, the high-nickel-based positive electrode active material, capable of achieving high capacity, may be applied to high-capacity, high-density rechargeable lithium batteries.

### Positive Electrode Binder

The binder serves to attach the positive electrode active material particles well to each other and also to attach the positive electrode active material well to the current collector COL1. Examples of the binder may include polyvinyl alcohol, carboxymethyl cellulose, hydroxypropyl cellulose, diacetyl cellulose, polyvinylchloride, carboxylated polyvinylchloride, polyvinylfluoride, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, a polymer including ethylene oxide, and/or the like, as non-limiting examples.

### Positive Electrode Conductive Material

The conductive material may be used to impart conductivity (e.g., electrical conductivity) to the electrode. Any material that does not cause chemical change (e.g., does not cause an undesirable chemical change in the rechargeable lithium battery) and conducts electrons may be used in the battery. Examples of the conductive material may include a carbon-based material such as natural graphite, artificial graphite, carbon black, acetylene black, Ketjen black, a carbon fiber, a carbon nanofiber, and a carbon nanotube; a metal-based material containing copper, nickel, aluminum, silver, and/or the like. in a form of a metal powder or a metal fiber; a conductive polymer such as a polyphenylene derivative; and/or a (e.g., any suitable) mixture thereof.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material (e.g., in a form of particles), and may further include a binder and/or a conductive material (e.g., an electrically conductive material).

For example, the negative electrode active material layer AML2 may include about 90 wt % to about 99 wt % of the negative electrode active material, about 0.5 wt % to about 5 wt % of the binder, and about 0 wt % to about 5 wt % of the conductive material, based on 100 wt % of a total weight of the negative electrode active material layer.

### Negative Electrode Binder

The binder may serve to attach the negative electrode active material particles well to each other and also to attach the negative electrode active material well to the current collector COL2. The binder may include a non-aqueous (e.g., water-insoluble) binder, an aqueous (water-soluble) binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, and/or a (e.g., any suitable) combination thereof.

The aqueous binder may be selected from among a styrene-butadiene rubber, a (meth)acrylated styrene-butadiene rubber, a (meth)acrylonitrile-butadiene rubber, a (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and/or a (e.g., any suitable) combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a (e.g., any suitable) combination thereof.

### Negative Electrode Conductive Material

The conductive material may be used to impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, Ketjen black, a carbon fiber, a carbon nanofiber, and a carbon nanotube; a metal-based material including copper, nickel, aluminum, silver, and/or the like, in a form of a metal powder or a metal fiber; a conductive polymer such as a polyphenylene derivative; and/or a (e.g., any suitable) mixture thereof.

### Negative Electrode Current Collector

The current collector COL2 may include a copper foil, a nickel foil, a stainless-steel foil, a titanium foil, a nickel foam, a copper foam, a polymer substrate coated with a conductive metal, and/or a (e.g., any suitable) combination thereof.

### Negative Electrode Active Material

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon and/or a (e.g., any suitable) combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and/or the like.

The lithium metal alloy includes an alloy of lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x≤2), a Si-Q alloy (where Q is selected from among an alkali metal, an alkaline-earth metal, a Group 13 element, a Group 14 element (excluding Si), a Group 15 element, a Group 16 element, a transition metal, a rare earth element, and/or a (e.g., any suitable) combination thereof), and/or a (e.g., any suitable) combination thereof. The Sn-based negative electrode active material may include Sn, SnOₓ (0<x≤2), e.g., SnO₂, a Sn-based alloy, and/or a (e.g., any suitable) combination thereof.

The silicon-carbon composite may be a composite of silicon and amorphous carbon. According to one or more embodiments, the silicon-carbon composite may be in a form of silicon particles and amorphous carbon applied onto the surface of each of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and for example, the primary silicon particles may be each coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

### Separator 30

Depending on the type or kind of the rechargeable lithium battery, the separator 30 may be present between the positive electrode 10 and the negative electrode 20. The separator 30 may include polyethylene, polypropylene, polyvinylidene fluoride, or a multilayer film of two or more layers thereof, or a mixed multilayer film such as a polyethylene/polypropylene two-layer separator, polyethylene/polypropylene/polyethylene three-layer separator, polypropylene/polyethylene/polypropylene three-layer separator, and/or the like.

The separator 30 may include a porous substrate and a coating layer including an organic material, an inorganic material, and/or a (e.g., any suitable) combination thereof on a surface (e.g., one or both surfaces (e.g., two opposite surfaces)) of the porous substrate.

The porous substrate may be a polymer film formed of any one polymer selected from among polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or a mixture of two or more thereof.

The organic material may include a polyvinylidene fluoride-based polymer or

a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof, but the present disclosure is not limited thereto.

The organic material and the inorganic material may be mixed in one coating layer, or a coating layer including an organic material and a coating layer including an inorganic material may be stacked.

### Electrolyte Solution ELL

The electrolyte solution ELL for a rechargeable lithium battery may include a non-aqueous organic solvent and a lithium salt.

The non-aqueous organic solvent may serve as a medium for transmitting ions taking part in the electrochemical reaction of a battery.

The non-aqueous organic solvent may be a carbonate-based solvent, an ester-based solvent, an ether-based solvent, a ketone-based solvent, an alcohol-based solvent, an aprotic solvent, or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. In addition, the ketone-based solvent may include cyclohexanone, and/or the like. The alcohol-based solvent may include ethanol, isopropyl alcohol, and/or the like, and the aprotic solvent may include nitriles such as R—CN (wherein R is a C2 to C20 linear, branched, or cyclic hydrocarbon group, and may include a double bond, an aromatic ring, or an ether bond), and/or the like; amides such as dimethylformamide; dioxolanes such as 1,3-dioxolane, 1,4-dioxolane, and/or the like; sulfolanes; and/or the like.

The non-aqueous organic solvents may be used alone or in combination of two or more thereof.

In addition, if (e.g., when) using a carbonate-based solvent, a cyclic carbonate and a chain carbonate may be mixed and used, and the cyclic carbonate and the chain carbonate may be mixed in a volume ratio of about 1:1 to about 1:9.

The lithium salt dissolved in the non-aqueous organic solvent supplies lithium ions in a rechargeable lithium battery, enables a basic operation of the rechargeable lithium battery, and improves transportation of the lithium ions between the positive electrode and the negative electrode. Examples of the lithium salt include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are each an integer of 1 to 20), lithium trifluoromethane sulfonate, lithium tetrafluoroethanesulfonate, lithium difluoro (oxalato) borate (LiDFOB), lithium difluorobis(oxalato)phosphate (LiDFBOP), and lithium bis(oxalato) borate (LiBOB).

### Rechargeable Lithium Battery

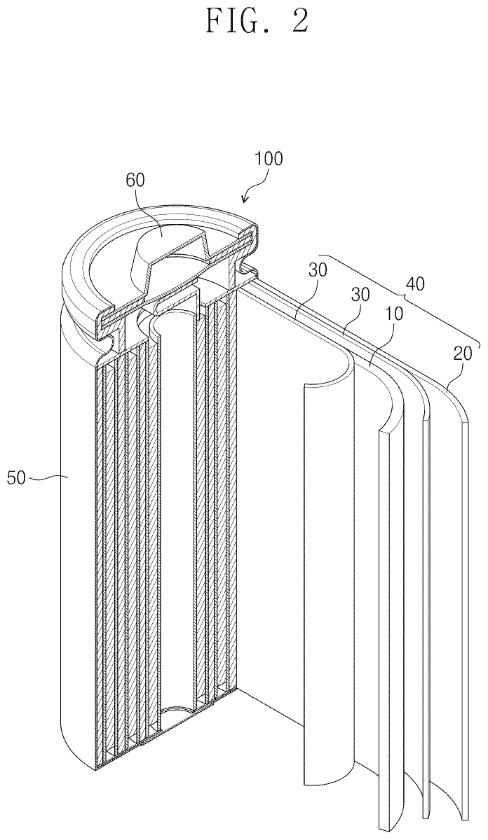

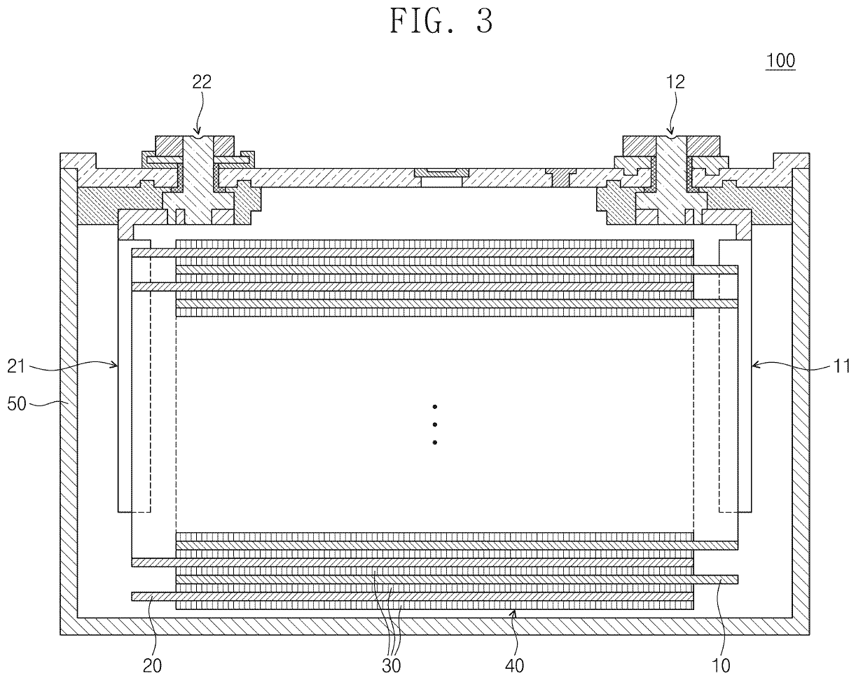

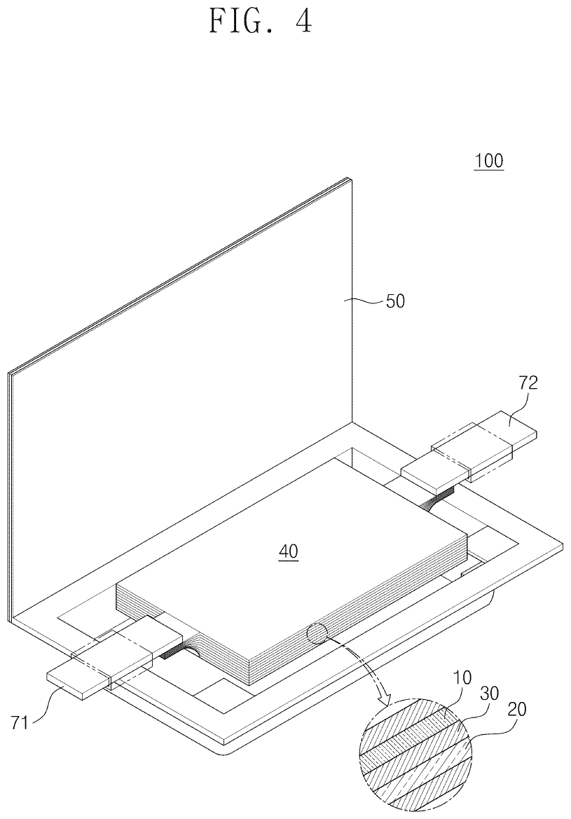

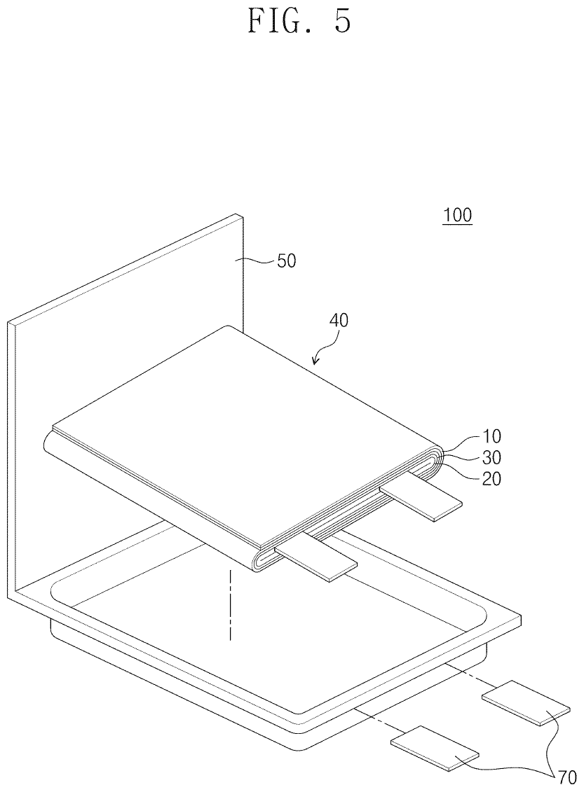

The rechargeable lithium battery may be classified into cylindrical, prismatic, pouch, coin-type or kind batteries, and/or the like. depending on their shape. FIGS. 2 to 5 are each a schematic view illustrating a rechargeable lithium battery according to one or more embodiments. FIG. 2 shows a cylindrical battery, FIG. 3 shows a prismatic battery, and FIGS. 4 and 5 each show a pouch-type or kind battery. Referring to FIGS. 2 to 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution. The rechargeable lithium battery 100 may include a sealing member 60 sealing the case 50, as shown in FIG. 2. In FIG. 3, the rechargeable lithium battery 100 may include a positive lead tab 11, a positive terminal 12, a negative lead tab 21, and a negative terminal 22. As shown in FIGS. 4 and 5, the rechargeable lithium battery 100 may include an electrode tab 70, which may include, for example, a positive electrode tab 71 and a negative electrode tab 72, serving as an electrical path for inducing the current formed in the electrode assembly 40 to the outside.

The rechargeable lithium battery according to one or more embodiments may be applied to automobiles, mobile phones, and/or one or more suitable types (kinds) of electric devices, as non-limiting examples.

Hereinafter, a rechargeable lithium battery according to one or more embodiments of disclosure and a preparation method thereof will be described in more detail.

The rechargeable lithium battery according to one or more embodiments of disclosure may include a high-nickel-based positive electrode active material. For example, the positive electrode active material according to one or more embodiments may include a compound represented by Formula 1.

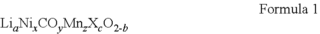

In Formula 1, 0.8≤a≤1.2, 0.8≤x≤1.0, 0≤y≤0.1, 0≤z≤0.1, 0≤c≤0.1, 0≤b≤0.05, and x+y+z+C=1, and X is at least one element selected from the group consisting of aluminum (Al), titanium (Ti), magnesium (Mg), zirconium (Zr), molybdenum (Mo), and niobium (Nb).

By including the high-nickel-based positive electrode active material, the rechargeable lithium battery may have improved capacity.

### Functional Additive

A positive electrode according to one or more embodiments of disclosure may include a functional additive ADD. The functional additive ADD may improve processability in preparation, stability, and performance of a rechargeable lithium battery including the positive electrode.

By using the functional additive ADD of the present disclosure, surface deterioration, due to side reaction occurred in a positive electrode active material, may be reduced. For example, complex problems in the rechargeable lithium battery, such as slurry gelation, increase in resistance, decrease in lifespan, and increase in the amount of gas generation, may be solved or alleviated. Consequently, the rechargeable lithium battery with improved processability and performance may be provided.

Referring to a layered positive electrode active material, such as the compound represented by Formula 1 previously described, recent development in the lithium battery industry is focusing on decreasing the content of cobalt (Co), which is expensive, and increasing the content (e.g., amount) of nickel (Ni), which can achieve (capable of realizing) high capacity.

However, as the nickel (Ni) content (e.g., amount) increases in the positive electrode active material, the frequency of side reactions may also increase due to reduction of nickel positive ions and their reaction with air and/or moisture on a surface of the positive electrode active material. As a result, internal lithium elution and the formation of lithium compounds cause deterioration in the reversibility of capacity and processability. In addition, in the case of a layered active material having high nickel content (e.g., amount), performance deterioration begins at the surface of the positive electrode active material. Thus, coating processes to protect the surface of the positive electrode active material and processes for structural stability have been introduced and investigated, but these lead to increased cost and decreased in energy density.

The functional additive ADD according to one or more embodiments of disclosure may be added to the positive electrode active material, thereby enhancing (exhibiting improved effects on the) processability, stability, and battery performance.

According to one or more embodiments, the functional additive ADD may contain a pyrazole-based compound. In the present disclosure, the pyrazole-based compound may refer to a compound containing a substituted or unsubstituted pyrazole group. The compound containing the pyrazole group may refer to a pyrazole derivative. In one or more embodiments, the compound may contain at least two substituted or unsubstituted pyrazole groups.

Pyrazole may be represented by the molecular formula C₃H₃N₂H, and is a heterocyclic compound containing carbon (C) and nitrogen (N). The pyrazole compound may refer to a heterocyclic compound characterized by a five-membered ring having two adjacent nitrogen atoms. For example, The pyrazole compound may contain a substituted or unsubstituted five-membered ring including one ═N—N— moiety.

By adding the functional additive ADD containing the pyrazole-based compound to the positive electrode active material, surface deterioration of the positive electrode active material may be reduced, and lifespan characteristics of the rechargeable lithium battery may be improved. For example, the nitrogen atom (N) in the functional additive ADD may combine with metal ions of the positive electrode active material to reduce the surface deterioration. Residual lithium in the positive electrode active material may be removed, and lithium elution may be suppressed or reduced. Even in the case of preparing a positive electrode active material layer as a thick-film electrode, stability and performance of the rechargeable lithium battery may be improved. In one or more embodiments, the positive electrode active material layer may have a thickness of about 10 micrometers (μm) to about 30 μm, about 5 μm to about 30 μm, about 10 μm to about 20 μm, about 10 μm to about 40 μm, about 20 μm to about 50 μm, about 30 μm to about 60 μm, about 40 μm to about 60 μm, about 40 μm to about 70 μm, or about 50 μm to about 70 μm. The thickness refers to a thickness of the positive electrode active material layer formed on a positive electrode current collector and measured in cross-section.

According to one or more embodiments, an amount of the functional additive ADD included in the positive electrode active material layer, on the basis of 100 parts by weight of the positive electrode active material, may be about 0.01 parts by weight to about 0.1 parts by weight, about 0.02 parts by weight to about 0.05 parts by weight, about 0.03 parts by weight to about 0.06 parts by weight, about 0.04 parts by weight to about 0.07 parts by weight, or about 0.05 parts by weight to about 0.08 parts by weight. If the amount of the functional additive is excessive (e.g., falls out of the above-mentioned numerical ranges), the resistance of the positive electrode may increase, so that the performance thereof may deteriorate. When the amount falls within the above-mentioned numerical ranges, the positive electrode active material may exhibit comprehensively improved effectiveness in stability, capacity, and/or the like.

Hereinafter, the pyrazole-based compound according to one or more embodiments of the present disclosure will be described in more detail.

In one or more embodiments, the functional additive ADD may contain a compound represented by Formula 2.

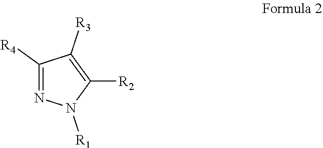

In Formula 2,

R₁ may be selected from the group consisting of hydrogen; deuterium; a halogen; and an alkyl group, an alkenyl group, an alkynyl group, a hydrocarbon ring, a cyclic alkyl group, an aryl group, and a heterocyclic group, which are each substituted or unsubstituted.

R₂, R₃, and R₄ may be each selected from the group consisting of hydrogen, deuterium, nitrogen, oxygen, a halogen, a hydroxyl group, and a substituted or unsubstituted alkyl group.

In one or more embodiments, the functional additive ADD may contain a compound represented by Formula 3.

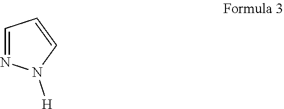

In one or more embodiments, the functional additive ADD may contain a compound represented by Formula 4.

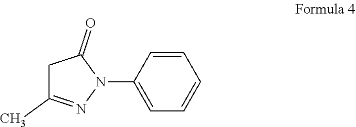

The above embodiments are listed as mere examples, and the embodiments of disclosure are not limited thereto.

According to one or more embodiments, the functional additive ADD may contain a pyrazole-based compound, which includes substituted or unsubstituted pyrazole groups. Pyrazole, a heterocyclic compound with the formula C₃H₃N₂H, features a five-membered ring with two adjacent nitrogen atoms. Adding this functional additive to the positive electrode active material should reduce surface deterioration and improve the lifespan of rechargeable lithium batteries by combining with metal ions and suppressing lithium elution. The positive electrode active material layer can have various suitable thicknesses as discussed above, and the amount of the functional additive should be within specific ranges to ensure optimal performance as discussed above. The functional additive may include compounds represented by one or more selected from among Formulas 2, 3, and 4, with various suitable substituents as discussed above.

### Electrolyte Layer

In one or more embodiments, a separate electrolyte layer may be included between the positive electrode and the negative electrode. The electrolyte layer may include the separator 30 and the electrolyte solution ELL. For example, in one or more embodiments of the present disclosure, the entire structure including the separator and the electrolyte solution may be collectively referred to as the electrolyte layer. The electrolyte layer may be formed of a film having a certain thickness.

In one or more embodiments, the electrolyte layer may be a gel polymer electrolyte layer including a gel polymer electrolyte. In the embodiments of including the gel polymer electrolyte (or semisolid electrolyte), a liquid electrolyte, and a gel polymer electrolyte containing a cross-linked polymer may be included in pores of a porous substrate constituting the separator 30. In these embodiments, the liquid electrolyte may be impregnated in a cross-linked polymer network having a cross-linked structure, and may thus be blocked from leaking out.

In one or more embodiments, the electrolyte layer may be a solid electrolyte layer including a solid electrolyte. The solid electrolyte layer may substitute for roles of the separator 30 and the electrolyte solution ELL.

In one or more embodiments, when the rechargeable lithium battery containing a gel polymer electrolyte (or semisolid electrolyte) or a solid electrolyte, the electrolyte layer may substitute for the roles of the separator 30 and the electrolyte solution ELL.

### Preparation Method of Rechargeable Lithium Battery

Hereinafter, a preparation method of a rechargeable lithium battery according to one or more embodiments will be described.

The preparation method of the rechargeable lithium battery may include preparing a positive electrode, preparing a negative electrode, and combining the positive electrode and the negative electrode to prepare the rechargeable lithium battery.

In one or more embodiments, the preparing of the positive electrode may include mixing a positive electrode active material, a conductive material, a binder, and a functional additive to prepare a positive electrode active material slurry, and applying the positive electrode active material slurry to a positive electrode current collector to form a positive electrode active material layer. The functional additive may include a compound containing a substituted or unsubstituted pyrazole group.

### Preparing Positive Electrode

In one or more embodiments, the positive electrode active material, the conductive material, the binder, and the functional additive may be mixed to prepare the positive electrode active material slurry. For the mixing method, any method that may be used by those skilled in the art, such as a wet method or a dry method, may be applied thereto, and embodiments of the present disclosure are not limited to a particular method.

In the step (e.g., act or task) of preparing the positive electrode active material slurry, the materials, previously described for each of the positive electrode active material, the conductive material, and the binder, may be used. For example, in one or more embodiments, a high-nickel-based positive electrode active material may be used for the positive electrode active material.

In the step (e.g., act or task) of preparing the positive electrode active material slurry, the functional additive of the present disclosure may be added. Description on the functional additive will not be provided as it is same as what is previously described, and the preparing of the positive electrode will be described in more detail.

For example, by adding the functional additive of the present disclosure in the step (e.g., act or task) of mixing and preparing the positive electrode active material slurry, the problem of deterioration in performance, which occurs in the preparing of the positive electrode, may be solved or markedly alleviated. Consequently, the positive electrode with improved processability and performance may be provided. In one or more embodiments, an amount of the functional additive to be added, on the basis of 100 parts by weight of the positive electrode active material, may be about 0.01 parts by weight to about 0.1 parts by weight, about 0.02 parts by weight to about 0.05 parts by weight, about 0.03 parts by weight to about 0.06 parts by weight, about 0.04 parts by weight to about 0.07 parts by weight, or about 0.05 parts by weight to about 0.08 parts by weight.

For example, the problems and issues in the step (e.g., act or task) of mixing the positive electrode active material slurry, such as increase in resistance and gas generation occurring due to side reaction with air/moisture, may be effectively solved or reduced. Formation of a lithium compound, binder denaturation, conductive material agglomerating, and/or the like, which consequentially cause gelation of the positive electrode active material slurry, may be effectively solved or alleviated.

In addition, because the functional additive of the present disclosure is mixed evenly in the positive electrode active material slurry, a positive electrode active material layer in which the functional additive is evenly dispersed may be formed. Even in the case that the positive electrode active material layer is a thick-film electrode, the stability of the rechargeable lithium battery may be improved. Consequently, the battery with improved stability and capacity may be prepared. In one or more embodiments, the positive electrode active material layer may have a thickness of about 10 μm to about 30 μm, about 5 μm to about 30 μm, about 10 μm to about 20 μm, about 10 μm to about 40 μm, about 20 μm to about 50 μm, about 30 μm to about 60 μm, about 40 μm to about 60 μm, about 40 μm to about 70 μm, or about 50 μm to about 70 μm. The thickness refers to a thickness of the positive electrode active material layer formed on a positive electrode current collector and measured in cross-section.

Thereafter, the prepared positive electrode active material slurry may be applied onto the positive electrode current collector and dried, and then rolling is performed to form a positive electrode active material layer.

### Preparing Negative Electrode

In one or more embodiments, a negative electrode active material, a binder, and a conductive material may be mixed to prepare a negative electrode active material slurry. The prepared negative electrode active material slurry may be applied onto a negative electrode current collector and dried, and then rolling is performed to prepare a negative electrode.

### Assembling Battery

The positive electrode and the negative electrode, prepared as previously described, may be combined to prepare a complete rechargeable lithium battery. A separator may be positioned between the positive electrode and the negative electrode, and an electrolyte solution may be introduced to prepare the rechargeable lithium battery. In one or more embodiments, an electrolyte layer may be provided between the positive electrode and the negative electrode to prepare a battery in a stacked form.

Any battery that includes a positive electrode active material layer, such as a general lithium-ion battery, or an all-solid-state battery, a semisolid-state battery, and/or the like, may be applied. In addition, a complete battery may be manufactured in a generally used form, such as prismatic, pouch, and cylindrical forms, without limitation.

Hereinafter, certain examples of the disclosure are described. The present disclosure includes not only the above-described embodiments, but also embodiments that have different designs or modifications in view of the present disclosure. In addition, techniques for modified practice of one or more embodiments of disclosure may also be included. Therefore, the scope of the disclosure should not be limited to the above-described embodiments, but should be determined by the appended claims and equivalents thereof.

### Example 1: Preparation of Positive Electrode Active Material Slurry

98.45 wt % of a positive electrode active material (LiNi_{0.94}Co_{0.04}Al_{0.02}O₂), 1.2 wt % of a polyvinylidene fluoride binder (PVdF), and 0.35 wt % of a carbon nanotube conductive material were mixed in an N-methylpyrrolidone solvent to prepare a positive electrode active material slurry. A functional additive containing a compound represented by Formula A-1 was added to the positive electrode active material slurry.

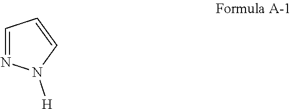

### Example 2: Preparation of Positive Electrode Active Material Slurry

A functional additive containing a compound represented by Formula A-2 was added to a positive electrode active material slurry.

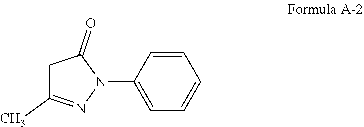

Except this, the positive electrode active material slurry was prepared in substantially the same manner as that of Example 1.

### Example 3: Preparation of Positive Electrode Active Material Slurry

A positive electrode slurry was prepared in substantially the same manner as that of Example 1 except that an amount of a functional additive was increased.

### Example 4: Preparation of Positive Electrode Active Material Slurry

A positive electrode slurry was prepared in substantially the same manner as that of Example 2 except that an amount of a functional additive was increased.

### Comparative Example 1: Preparation of Positive Electrode Active Material Slurry

A functional additive containing oxalic acid was added to a positive electrode active material slurry. Except this, the positive electrode slurry was prepared in substantially the same manner as that of Example 1.

### Comparative Example 2: Preparation of Positive Electrode Active Material Slurry

A functional additive containing oxalic acid was added to a positive electrode active material slurry. The positive electrode slurry was prepared in substantially the same manner as that of Comparative Example 1 only except that the amount of the functional additive was different.

The above-described preparations according to the examples and the comparative examples of disclosure are listed in Table 1. The amount of the functional additive is expressed as parts by weight of the functional additive based on 100 parts by weight of the positive electrode active material.

TABLE 1

| | Functional additive |
|---|---|
| | (Parts by weight of functional additive based on 100 parts |
| | by weight of positive electrode active material) |
| Example 1 | Pyrazole 0.05 parts by weight |
| Example 2 | Pyrazole derivative of Formula A-2 0.05 parts by weight |
| Example 3 | Pyrazole 0.2 parts by weight |
| Example 4 | Pyrazole derivative of Formula A-2 0.2 parts by weight |
| Comparative | Oxalic acid 0.1 parts by weight |
| Example 1 | |
| Comparative | Oxalic acid 0.15 parts by weight |
| Example 2 | |

### Evaluation Example 1: Viscosity Change while Slurry is Left to Stand after Agitated

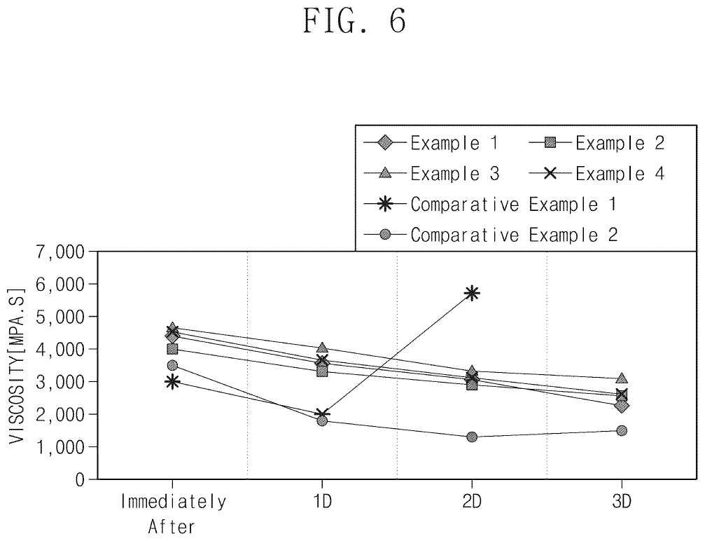

After the functional additive was added, the agitating of the positive electrode active material slurry was stopped and left to stand, and then change in viscosity of the slurry was observed. The experiment results are shown in Table 2 and FIG. 6.

TABLE 2

| | Viscosity (mPa · s) | | | |
|---|---|---|---|---|
| | Immediately | 1 day after | 2 days after | 3 days after |
| | after mixing | agitating | agitating | agitating |
| Example 1 | 4,366 | 3,505 | 3,021 | 2,244 |
| Example 2 | 4,013 | 3,292 | 2,951 | 2,558 |
| Example 3 | 4,668 | 3,972 | 3,319 | 3,047 |
| Example 4 | 4,508 | 3,646 | 3,124 | 2,590 |
| Comparative | 2,988 | 1,952 | 5,720 | — |
| Example 1 | | | | |
| Comparative | 3,513 | 1,805 | 1,312 | 1,465 |
| Example 2 | | | | |

It can be seen that the viscosity of each of the positive electrode active material slurries, according to the examples of the present disclosure, decreased over time after mixing and agitating.

In contrast, in the case of Comparative Example 1, it can be seen that the viscosity rather increased significantly due to agglomerating caused by binder denaturation while the positive electrode active material slurry was left to stand after agitating (i.e., the viscosity significantly increased due to agglomeration caused by binder denaturation while the positive electrode active material slurry was left to stand after agitation). It can be seen that, in order to maintain an appropriate or suitable viscosity, a larger amount of the functional additive was needed, as shown in the result of Comparative Example 2.

### Evaluation Example 2: Surface Analysis of Positive Electrode Active Material

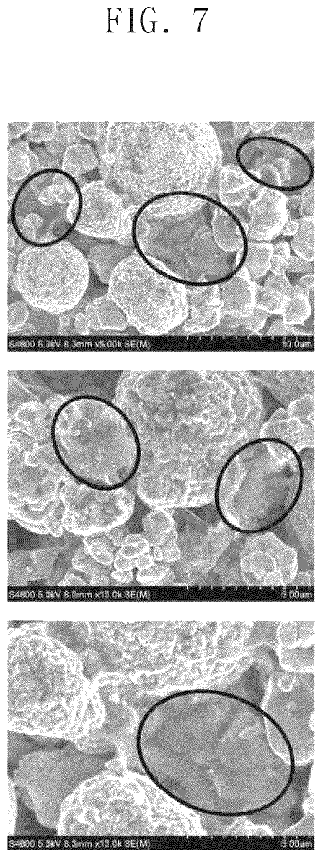

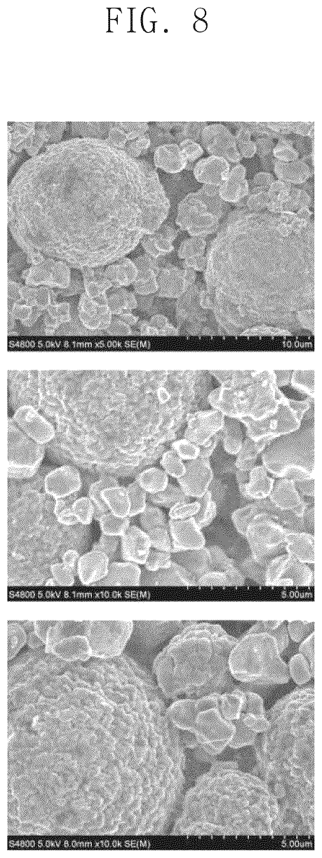

FIG. 7 shows scanning electron microscope (SEM) images obtained by analysis on a surface of the positive electrode active material according to Comparative Example 2. FIG. 8 shows SEM images obtained by analysis on a surface of the positive electrode active material according to Example 2.

Referring to FIG. 7, it can be seen that, in the positive electrode active material slurry according to the comparative example, agglomerating of the conductive material occurred and agglomerates were formed. In contrast, referring to FIG. 8, it can be seen that fewer agglomerates were formed on the surface of the positive electrode active material according to the example of the present disclosure, and the surface of the positive electrode active material was even.

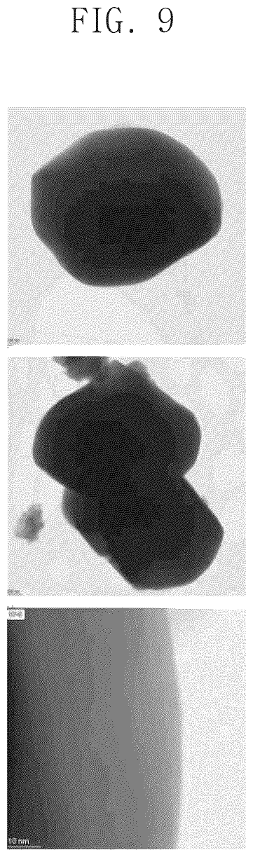

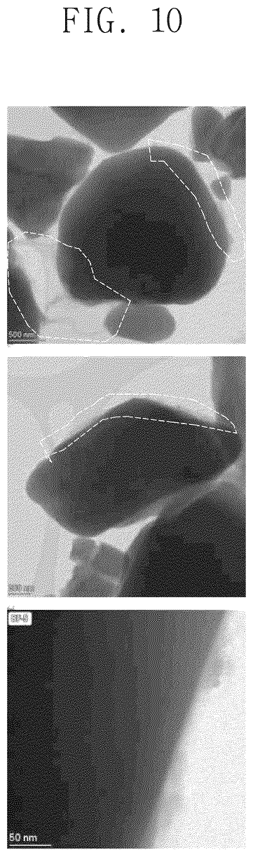

FIG. 9 shows transmission electron microscope (TEM) images obtained by analysis on the surface of the positive electrode active material according to Comparative Example 2. FIG. 10 shows TEM images obtained by analysis on the surface of the positive electrode active material according to Example 2.

Comparing FIG. 9 to FIG. 10, it can be seen that a film of several to tens of nanometers was present only on the surface of the positive electrode active material according to the example of the present disclosure.

### Evaluation Example 3: Resistance Evaluation

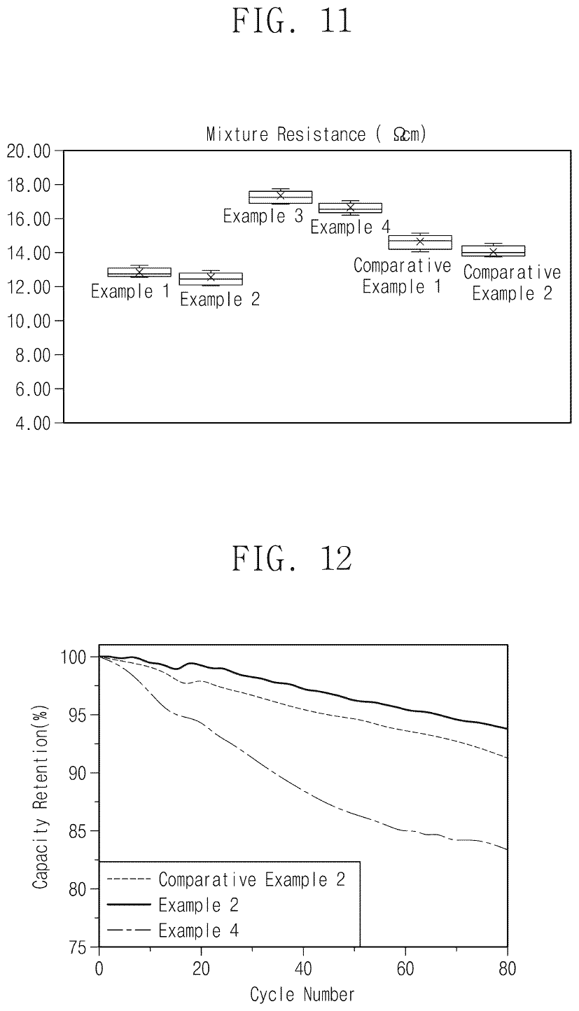

Resistance values of each of positive electrode mixtures (i.e., mixture of the positive electrode active material, the binder, the conductive material, the functional additive, etc.) according to some of the examples and comparative examples were measured, and shown in FIG. 11. It can be seen that the resistance values of each of the positive electrode mixtures according to Example 1 and Example 2 of the disclosure were lower than that of Comparative Example 1 and 2. However, it can be seen that, in the case of including excessive amount of the functional additive, the resistance increases, as shown in the results of Examples 3 and 4, leading to a deterioration in performance.

### Evaluation Example 4: Lifespan Evaluation

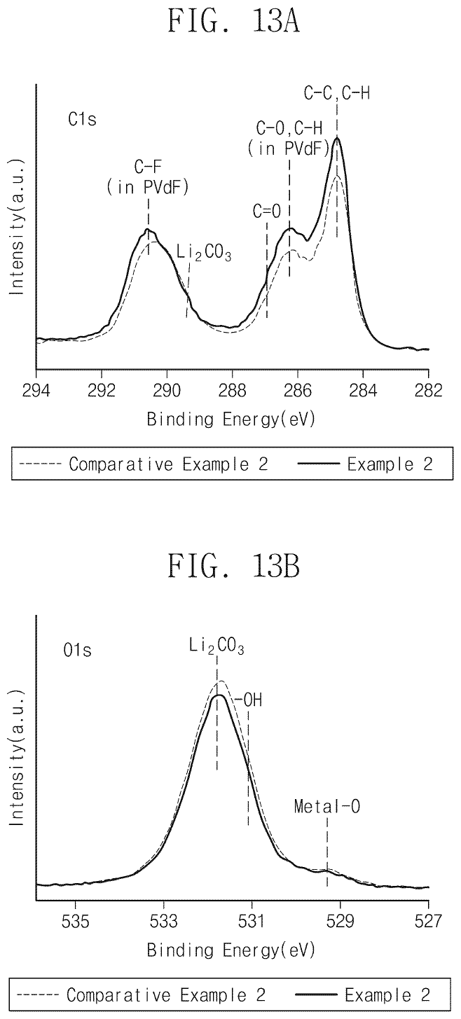

Coin cells were manufactured with the respective positive electrode prepared using each of the positive electrode active material slurries (1 day after agitating) according to the examples and comparative examples, and then the lifespan characteristics thereof were each evaluated. The evaluation results are shown in Table 3 and FIG. 12.

TABLE 3

| | Lifespan characteristics (%) |
|---|---|
| | at 50 cycles |
| Example 2 | 96.2 |
| Example 4 | 85.9 |
| Comparative | 94.6 |
| Example 2 | |

It can be seen that the battery/cell according to Example 2 has superior (more excellent or suitable) lifespan characteristics than the battery/cell according to Comparative Example 2. However, referring to the results of Examples 2 and 4, it can be seen that the lifespan characteristics deteriorate if (e.g., when) the excessive amount of functional additive was included.

### Evaluation Example 5: Results of XPS Analysis

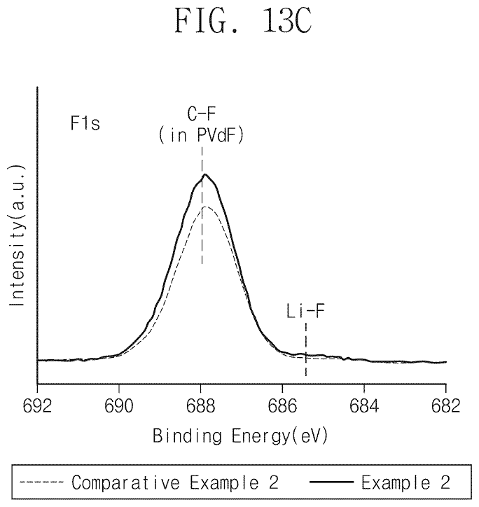

The surface of each of the positive electrode active materials according to Example 2 and Comparative Example 2 was analyzed with X-ray photoelectron spectroscopy (XPS). The results are shown in FIGS. 13A, 13B, and 13C.

Referring to FIGS. 13A and 13B, it can be seen that the intensity of peak (—CO₃) according to the example was lower than that according to the comparative example. This indicates that a surface protection layer was formed on the positive electrode active material due to the functional additive of the present disclosure. For example, this means that, during the positive electrode active material slurry mixing, lithium elution in the positive electrode active material was suppressed or reduced, and thus formation of lithium carbonate (Li₂CO₃) was suppressed or reduced.

Referring to FIGS. 13A and 13C, the C—F peak increased in the case of the example, compared to the comparative example, and this indicates that denaturation of a PVdF binder, caused by de-hydrofluorination (de-HF) reaction, was reduced, and as a result, formation of agglomerates was suppressed or reduced.

As a result, it can be seen that the inclusion of the functional additive of the present disclosure brought about a protective effect on the surface of the positive electrode active material, thereby improving the stability.

A positive electrode according to one or more embodiments may have a positive electrode active material with improved surface protection by including the functional additive of the present disclosure, thereby improving lifespan and output characteristics of a rechargeable lithium battery.

A preparation method according to one or more embodiments may solve and/or dramatically alleviate problems that occur in preparation of a positive electrode, such as binder denaturation, conductive material agglomerating, and slurry gelation, by including the functional additive of the present disclosure.

Again, a positive electrode, according to one or more embodiments, may include the functional additive of the present disclosure, enhancing surface protection and thereby improving the lifespan and output characteristics of a rechargeable lithium battery. Additionally, the preparation method with the functional additive may alleviate issues such as binder denaturation, conductive material agglomeration, and slurry gelation.

In the present disclosure, expressions such as “at least one of,” “one of,” and “selected from,” when preceding a list of elements, modify the entire list of elements and do not modify the individual elements of the list. For example, “at least one of a, b or c”, “at least one selected from a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof. The “/” utilized herein may be interpreted as “and” or as “or” depending on the situation.

In the context of the present disclosure and unless otherwise defined, the terms “use,” “using,” and “used” may be considered synonymous with the terms “utilize,” “utilizing,” and “utilized,” respectively.

In present disclosure, The term “Group” as utilized herein refers to a group of the Periodic Table of Elements according to the 1 to 18 grouping system of the International Union of Pure and Applied Chemistry (“IUPAC”).

As used herein, the terms “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

An electrode manufacturing apparatus, a battery manufacturing apparatus, a battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Although one or more embodiments of the present disclosure have been described, it is understood that the present disclosure should not be limited to these embodiments but one or more suitable changes and modifications can be made by one ordinary skilled in the art within the spirit and scope of the present disclosure as hereinafter claimed and equivalents thereof.

What is claimed is:

1. A positive electrode active material slurry, comprising:
a positive electrode active material;
a conductive material;
a binder; and
a functional additive,
wherein the functional additive comprises a compound containing a substituted or unsubstituted pyrazole group.

2. The positive electrode active material slurry as claimed in claim 1, wherein the positive electrode active material comprises a compound represented by Formula 1: 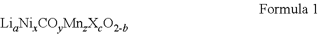
in Formula 1, 0.8≤a≤1.2, 0.8≤x≤1.0, 0≤y≤0.1, 0≤z≤0.1, 0≤c≤0.1, 0≤b≤0.05, and x+y+Z+C=1, and X being at least one element selected from the group consisting of Al, Ti, Mg, Zr, Mo, and Nb.

3. The positive electrode active material slurry as claimed in claim 1, wherein the compound comprises at least two substituted or unsubstituted pyrazole groups.

4. The positive electrode active material slurry as claimed in claim 1, wherein an amount of the functional additive is about 0.01 parts by weight to about 0.1 parts by weight on the basis of 100 parts by weight of the positive electrode active material.

5. The positive electrode active material slurry as claimed in claim 1, wherein the compound is represented by Formula 2: 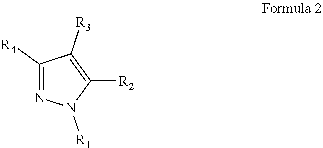
wherein, in Formula 2,
R₁ is selected from the group consisting of hydrogen, deuterium, a halogen, and an alkyl group, an alkenyl group, an alkynyl group, a hydrocarbon ring group, a cyclic alkyl group, an aryl group, and a heterocyclic group, which are each substituted or unsubstituted, and
R₂, R₃, and R₄ are each independently selected from the group consisting of hydrogen, deuterium, nitrogen, oxygen, a halogen, a hydroxyl group, and a substituted or unsubstituted alkyl group.

6. The positive electrode active material slurry as claimed in claim 1, wherein the compound is represented by Formula 3:

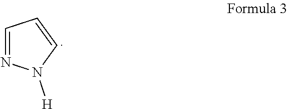

7. The positive electrode active material slurry as claimed in claim 1, wherein the compound is represented by Formula 4:

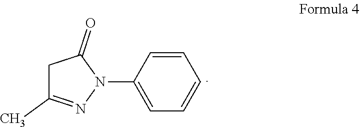

8. The positive electrode active material slurry as claimed in claim 1, wherein an amount of the binder is about 0.5 wt % to about 5 wt % on the basis of 100 wt % of a total weight of the positive electrode active material slurry.

9. The positive electrode active material slurry as claimed in claim 1, wherein an amount of the conductive material is about 0.5 wt % to about 5 wt % on the basis of 100 wt % of a total weight of the positive electrode active material slurry.

10. The positive electrode active material slurry as claimed in claim 1, wherein the binder comprises at least one selected from the group consisting of polyvinyl alcohol, carboxymethyl cellulose, hydroxypropyl cellulose, diacetyl cellulose, polyvinylchloride, carboxylated polyvinylchloride, polyvinylfluoride, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and a polymer comprising ethylene oxide.

11. The positive electrode active material slurry as claimed in claim 1, wherein the conductive material comprises: a carbon-based material comprising natural graphite, artificial graphite, carbon black, acetylene black, Ketjen black, a carbon fiber, a carbon nanofiber, a carbon nanotube, or any combination thereof; a metal-based material containing copper, nickel, aluminum, or silver, each in a form of a metal powder or a metal fiber; a conductive polymer comprising a polyphenylene derivative; or a mixture thereof.

12. A rechargeable lithium battery, comprising:
a positive electrode;
a negative electrode; and
an electrolyte layer between the positive electrode and the negative electrode,
wherein,
the positive electrode comprises a positive electrode current collector, and a positive electrode active material layer on the positive electrode current collector,
the negative electrode comprises a negative electrode current collector, and a negative electrode active material layer on the negative electrode current collector, and
the positive electrode active material layer is prepared by utilizing the positive electrode active material slurry as claimed in claim 1.

13. The rechargeable lithium battery as claimed in claim 12, wherein the positive electrode active material layer has a thickness of about 40 μm to about 60 μm.

14. The rechargeable lithium battery as claimed in claim 12, wherein an amount of the functional additive in the positive electrode active material layer is about 0.01 parts by weight to about 0.1 parts by weight on the basis of 100 parts by weight of the positive electrode active material in the positive electrode active material layer.

15. The rechargeable lithium battery as claimed in claim 12, wherein the conductive material comprises: a carbon-based material comprising natural graphite, artificial graphite, carbon black, acetylene black, Ketjen black, a carbon fiber, a carbon nanofiber, a carbon nanotube, or any combination thereof; a metal-based material containing copper, nickel, aluminum, or silver, each in a form of a metal powder or a metal fiber; a conductive polymer comprising a polyphenylene derivative; or a mixture thereof.

16. The rechargeable lithium battery as claimed in claim 12, wherein the electrolyte layer comprises a gel polymer electrolyte.

17. The rechargeable lithium battery of claim 12, wherein the electrolyte layer comprises a solid electrolyte.

18. A preparation method of a rechargeable lithium battery, the preparation method comprising:
preparing a positive electrode;
preparing a negative electrode; and
combining the positive electrode and the negative electrode to prepare the recharge lithium battery,
wherein the preparing of the positive electrode comprises
mixing a positive electrode active material, a conductive material, a binder, and a functional additive to form a positive electrode active material slurry, and
applying the positive electrode active material slurry to a positive electrode current collector to form a positive electrode active material layer, and
the functional additive comprises a compound containing a substituted or unsubstituted pyrazole group.

19. The preparation method as claimed in claim 18, wherein an amount of the functional additive is about 0.01 parts by weight to about 0.1 parts by weight on the basis of 100 parts by weight of the positive electrode active material.

20. The preparation method of claim 18, wherein the positive electrode active material comprises a compound represented by Formula 1: 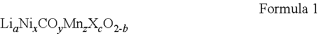
in Formula 1, 0.8≤a≤1.2, 0.8≤x≤1.0, 0≤y≤0.1, 0≤z≤0.1, 0≤c≤0.1, 0≤b≤0.05, and x+y+Z+C=1, and X being at least one element selected from the group consisting of Al, Ti, Mg, Zr, Mo, and Nb.
